(19) United States
(12) Patent Application Publication
(10) Pub. No.: US 2008/0131279 A1
(43) Pub. Date: Jun. 5, 2008

(54) WIND ENERGY PLANT WITH A NACELLE

(75) Inventors: Merten Behnke, Alt Farpen (DE); Harald Keller, Hamburg (DE); Joachim Nitzpon, Hamburg (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: Nordex Energy GmbH, Norderstedt (DE)

(21) Appl. No.: 11/772,306

(22) Filed: Jul. 2, 2007

(30) Foreign Application Priority Data
Jun. 28, 2006 (DE) 10 2006 029 640.0

(51) Int. Cl. F03D 7/04; F01D 7/00; F03D 7/00; H02P 5/00; H02P 6/08

(52) U.S. Cl. 416/26; 416/43; 318/434; 318/51

(57) ABSTRACT

A wind energy plant with a nacelle, the azimuth orientation of which is motor-driven adjustable via an adjustment device, the adjustment device having at least one asynchronous motor with gearbox and at least one holding brake, wherein a control unit for the asynchronous motor is provided, which limits the moment occurring on the asynchronous motor to a predetermined maximum value.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to a wind energy plant which has a nacelle, the orientation of which is motor-driven adjustable via an adjustment device.

The motor-driven azimuth drive of the nacelle for a wind energy plant is commonly known. According to Erich Hau, Windkraftanlagen, 3^{th} edition, Springer-Verlag, page 309 and following pages, the azimuth drive is also designated as an azimuth adjustment system. The basic objective of this system is considered to be the automatic orientation of the rotor and the nacelle towards the wind direction. E. Hau points out in this respect that the azimuth drive is an autonomous structural component in the wind energy plant, which forms the transition from the nacelle to the tower head, seen from the point of view of construction. Simply speaking, the adjustment device rotates the nacelle with the rotor around the longitudinal axis of the tower. In the adjustment device, the actuating drive at the one hand and a caliper or rotation restrainer on the other hand can be distinguished. The actuating drive has a motor, a gearbox and an electric brake.

From DE 199 20 504 C2, the entire contents of which is incorporated herein by reference, a tracking system for a wind energy plant is known. In the azimuth drive system, the actuating drive generates a holding moment on the adjustment device during the rest period of the nacelle, from time to time or continuously. This is achieved by providing a three-phase asynchronous motor as the actuating drive, to which a direct current is applied for generating a holding moment.

From DE 100 23 440 C1, the entire contents of which is incorporated herein by reference, an azimuth drive is known wherein the actuating drive is ramp-like started and stopped again during the adjustment of the nacelle. For this purpose, the actuating drive is realised as a three-phase asynchronous motor, which is driven by a three-phase current of variable frequency.

From DE 103 07 929 A1, the entire contents of which is incorporated herein by reference, an azimuth drive is known wherein for protection of the actuating drive, the same is fastened via a safety clutch or slipping clutch. The background of this is that during the tracking movement, usually holding brakes are in engagement in order to ensure the necessary damping of the tracking movement. For this reason, the drives are dimensioned such that they can overcome the holding forces of the brake. In spite of the damping by the brake, load peaks due to high yawing moments occur on the motors during the operation of the wind energy plants, which can lead to damage or destruction of the involved components. For the protection of the actuating drives, it is therefore provided that the fastening thereof has a friction surface for clamping fast the drive, the clamping force being dimensioned such that from on a given mechanical stress, the drive is movable in its fastening.

A so-called pitch plants, wind energy plants are known which can adjust the angle of attack of a rotor blade through a rotation of the rotor blade around its longitudinal axis. For this purpose, the rotor blade is shiftably mounted on a rotor hub, wherein the orientation of the rotor blade around its longitudinal direction is shifted via one or plural motors. In the spirit of the present invention, it is not distinguished between the adjustment device for the pitch drive and for the wind direction tracking. Both adjustment devices turn the position of either the nacelle or of the rotor blade with respect to its rotational axis. In the nacelle, the rotational axis is normally equivalent to the longitudinal axis of the tower, while in the pitch drive, the rotational axis coincides with the longitudinal axis of the rotor blade. Neglecting these geometrical differences with regard to dimensioning, the adjustment drives have equal functions and a largely similar construction design.

The present invention is based on the objective to provide an adjustment device for a wind energy plant which permits a simple construction and which in particular permits to avoid any design for too high torques in the dimensioning of the adjustment device.

Further advantageous embodiments, realisations and aspects of the present invention result from the dependent claims, the description and the attached drawings.

### BRIEF SUMMARY OF THE INVENTION

The wind energy plant according to the present invention has a nacelle, the azimuth orientation of which is motor-driven adjustable via an adjustment device. The azimuth orientation determines the orientation of the nacelle and the rotor. The adjustment device has at least one motor, preferably with gearbox and at least one holding brake. The motor with its gearbox serves as actuating drive for orienting the position of the nacelle in the wind. Also, the present invention is related to an adjustment drive for a rotor blade, by which the rotor blade can be shifted around its longitudinal axis. Even here again, a gearbox and a holding brake can be provided.

A control unit is provided for the motor(s). The control unit limits the moment occurring on the motor to a predetermined maximum value. Preferably, an asynchronous motor is provided as the motor. In this, the predetermined maximum value is preferably smaller than the motor breakdown torque of the motor. According to the present invention, there is provided a control unit for the motor which controls a predetermined maximum value for the torque. The particular advantage of this control unit is that the gearbox has to be dimensioned only up to the maximum value for the torque. When asynchronous motors are used, a field weakening of the asynchronous motor takes place at rotational speeds above the synchronous speed, which results in a moment reduction. With the control unit according to the present invention, a smaller field weakening at supersynchonous speed can be achieved by using a stronger motor. The use of the stronger motor results in a higher breakdown torque, which would overload the gearbox without torque limitation. Only with the torque limitation according to the present invention, using such motors becomes possible. Furthermore, an electric brake is used as a service brake, which is dimensioned for the maximum value of the torque and which can hold it. Above the maximum holding moment, slipping of the electric brake is permitted.

Preferably, the control unit limits the torque generated by the motor to a first predetermined torque value during the adjustment operation of the nacelle or of the rotor blade. The first predetermined torque value is suitably smaller or equal to the maximum value for the torque for which the gearbox has been dimensioned.

The control unit is also provided for holding the nacelle or the rotor blade, a hydraulic and/or an electric brake being closed for this purpose. The generated torque for holding by the electric brake is limited to a second predetermined torque value. Preferably, again the second predetermined torque value is smaller or equal to the maximum value for the torque.

In one preferred realisation of the adjustment device, two or more asynchronous motors are provided, which can be commonly driven by one control unit. The control unit is preferably also formed such that it drives the asynchronous motor(s) as well as the electric brake and/or the hydraulic holding brake. The holding brake can be realised as a hydraulic brake. A common control unit for adjustment drive and holding brake permits to drive them reliably matching each other.

In order to damp the dynamics of the movement in the adjustment operation, the control unit preferably does not unlock the hydraulic brake completely during the adjustment operation.

In one preferred realisation, the gearbox of the motor is dimensioned for the maximum value and the asynchronous motor is dimensioned significantly greater in its breakdown torque.

### BRIEF DESCRIPTION OF THE SEVERAL VIEWS OF THE DRAWINGS

A preferred embodiment of the method of the present invention will be explained by means of an example for the azimuth orientation of the nacelle in the following.

FIG. 1 shows a sectional view of the azimuth drive from the side,

FIG. 2 shows a schematic view for the course of the moments vs. the rotational speed for a three-phase asynchronous motor, and

FIG. 3 shows a schematic view for the course of the moments vs. the rotational speed when driving with limited maximum moment.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

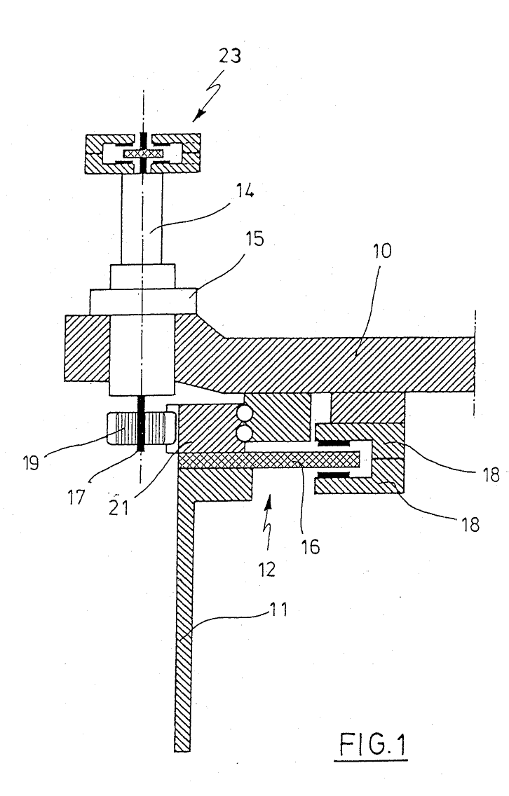

FIG. 1 shows a cut-out of a machine carrier 10, which has a generator and a drive train with the rotor at the nacelle side. The machine carrier 10 is rotatably mounted on the tower 11, a revolving joint 12 with outer denticulation being provided for this purpose. A three-phase asynchronous motor 14 is set into the machine carrier, which is provided with a gearbox 15. On the outside of the yaw beating, a brake disc 16 is arranged, which is partly overlapped by calipers 18. The calipers 18 are uniformly distributed along the perimeter of the brake disc 18 and cover essentially an angle of about 270°. The calipers 18 are hydraulically actuated via a central hydraulic unit which is provided on the machine carrier 10 at the nacelle side. The calipers 18 are “fail safe” mounted, so that the brake is opened at regular operation of the braking system only. The asynchronous motor 14 is passively ventilated and is located on the fast shaft of a multi-stage planetary gearbox as a torque converter. The azimuth system can also have several asynchronous motors with gearbox.

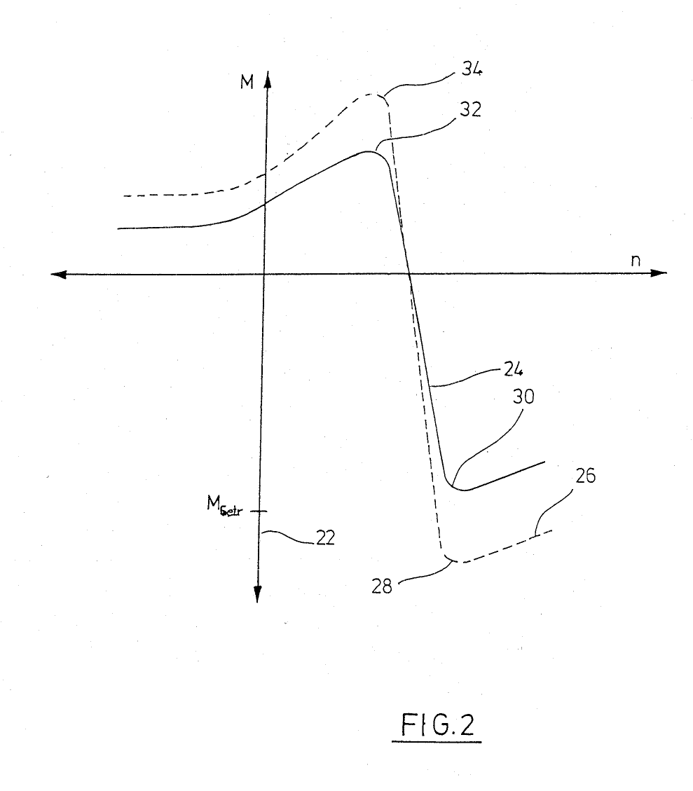

FIG. 2 shows the course of the torque vs. the rotational speed for a three-phase asynchronous motor, in a schematic view. The course represented in FIG. 2 shows the torque generated by the motor as a function of the rotational speed. The course of the torque/rotational speed characteristic curve is per se known for three-phase asynchronous motors. For the appreciation of the invention it is important that the permitted maximum torque determined by the gearbox limits the selection of the asynchronous motor. For instance, when the permitted maximum torque is set to a value M_{getr} 22, the selection of the three-phase asynchronous motors for the azimuth system is limited through this. In the shown example from FIG. 2, it is then only possible to choose a motor with the characteristic curve 24. In this motor, the amount of the generator and the motor breakdown torque is below the maximum permitted gearbox moment. Thus, the maximum moment of the gearbox determines the selection of the three-phase asynchronous motor. The use of a “stronger” three-phase asynchronous motor, which has a characteristic curve 26, can therefore not be considered, because its generator breakdown torque 28 is greater in its amount than the maximum permitted moment for the gearbox. But the generator breakdown torque 28 of the moment vs. rotational speed characteristic curve 26 and the generator breakdown torque 30 of the moment vs. rotational speed characteristic curve 24 are the maximum occurring torques to which the drives are driven into the supersynchronous region, by a wind gust for instance. Because the azimuth adjustment system of the wind energy plant has to be dimensioned for this case of load as well, high demands result for the maximum moments of the gearbox. In this, as usual the motor breakdown torques 32 and 34 of the represented three-phase asynchronous motors are smaller than the generator breakdown torques 30 and 28, respectively.

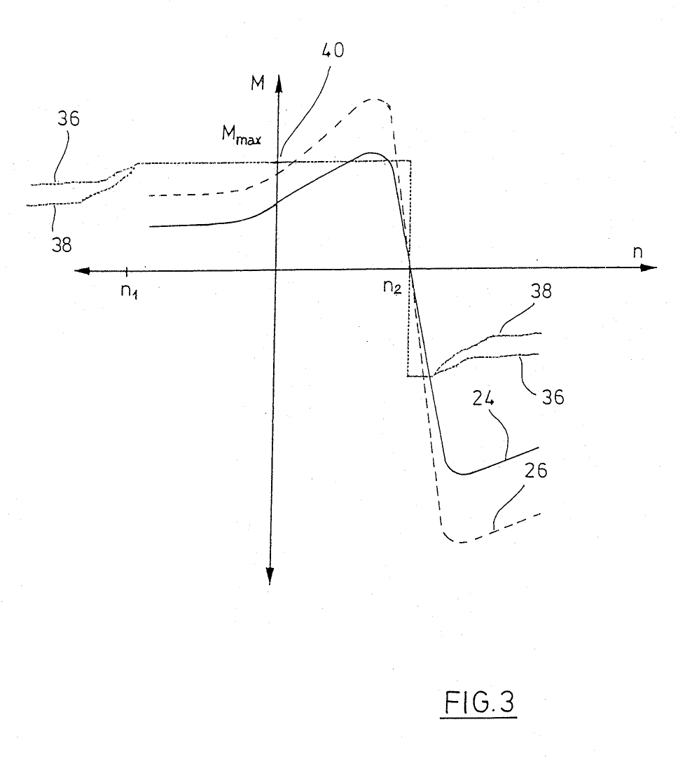

FIG. 3 shows the corresponding moment characteristic curves 36, 38 when driving according to the present invention, in a comparison with the known moment vs. rotational speed characteristic curves 24, 26. In contrary to the torques drawn in FIG. 2, the amount of the torque is represented even at opposite rotational speed here. As can be seen from FIG. 3, the torque is limited for rotational speeds in the range between n1 and n2. For rotational speed exceeding this range, i.e. for rotational speeds smaller than n1 and rotational speeds greater than n2, when taking into account the rotational direction in the rotational speed, the torques drop off. This is due to the dimensioning of the three-phase asynchronous motor and corresponds to the field weakening regions also represented in the characteristic curves 24 and 26, in which the moment drops off.

As can be clearly seen from FIG. 3, the drop-off of the torques for rotational speeds outside the interval (n1, n2) is significantly weaker in the characteristic curve 36 than in the characteristic curve 38, i.e. a high torque can be established over a greater range of the rotational speed. As the greatest moment is limited to the maximum moment Mₘₐₓ, even the gearbox can be dimensioned for the maximum moment Mₘₐₓ, wherein a security factor has to be taken into account, as the case may. In spite of the limited dimensioning of the gearbox, a three-phase asynchronous motor can then be used which can generate significantly greater torques than the maximum torque Mₘₐₓ in certain rotational speed regions, but which is limited through the driving by the frequency converter. The advantage of such three-phase asynchronous motors is that in the region of field weakening, the moment does not drop off in that degree as is the case in a three-phase asynchronous motor whose generator breakdown torque corresponds to the maximum permitted breakdown torque. In conventional azimuth drives of the state of the art, an electric brake is dimensioned such that by repeated slipping of the electric brake, the latter and/or neighbouring components are damaged. Taking into account this background, known azimuth systems are dimensioned such that they theoretically slip only rarely or not at all even in cases of extreme load. In the invention, slipping of the electric brake is permitted at low torque values already, through the dimensioning of the gearbox to a maximum moment. The braking energy generated in this is dispersed to the surroundings in the form of heat.

The three-phase asynchronous motor described above and an equivalent gearbox can also be correspondingly dimensioned for the pitch drive.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A wind energy plant with a nacelle and a rotor with at least one rotor blade adjustable around its longitudinal axis, wherein an adjustment device is provided, through which an azimuth orientation of the nacelle or a pitch orientation of the at least one rotor blade is motor-driven adjustable, the adjustment device having at least one motor (14), characterised in that a control unit for the motor (14) is provided, which limits the moment occurring on the motor to a predetermined maximum value (Mₘₐₓ) (40).

2. A wind energy plant according to claim 1, characterised in that an asynchronous motor is provided as the motor.

3. A wind energy plant according to claim 1, characterised in that an adjustment device for the azimuth orientation of the nacelle is provided.

4. A wind energy plant according to claim 1, characterised in that an adjustment device for the pitch orientation of the at least one rotor blade is provided.

5. A wind energy plant according to claim 1, characterised in that the control unit for the adjustment operation limits the torque generated by the motor to a first predetermined torque value.

6. A wind energy plant according to claim 5, characterised in that the first predetermined torque value is smaller or equal to the maximum value (Mₘₐₓ) (40) for the torque.

7. A wind energy plant according to claim 1, characterised in that an electric brake (23) for holding the nacelle and/or the pitch orientation of the rotor blade is provided, which limits a torque occurring on the gearbox to a second predetermined torque value.

8. A wind energy plant according to claim 7, characterised in that the second predetermined torque value is smaller than or equal to the maximum value (Mₘₐₓ) for the torque.

9. A wind energy plant according to claim 1, characterised in that one control unit is provided for two or more motors.

10. A wind energy plant according to claim 1, characterised in that the control unit drives the motor(s) as well as a holding brake (16, 18).

11. A wind energy plant according to claim 10, characterised in that the control unit does not unlock the holding brake (16, 18) completely for the adjustment operation.

12. A wind energy plant according to claim 2, characterised in that the asynchronous motor is dimensioned such that the amount of its breakdown torque is greater than the predetermined maximum value (Mₘₐₓ).
